(19) United States
(12) Patent Application Publication
(10) Pub. No.: US 2023/0249952 A1
(43) Pub. Date: Aug. 10, 2023

(54) INTEGRATED LIFTING CONTROL SYSTEM FOR CONTROLLING HORIZONTAL MAINTENANCE AND LOAD OF WEIGHT LIFTED VERTICALLY

(71) Applicant: GLORIA CO., LTD., Changwon (KR)

(72) Inventor: Yung Hyun YOO, Changwon (KR)

(21) Appl. No.: 17/742,261

(22) Filed: May 11, 2022

(30) Foreign Application Priority Data
Feb. 10, 2022 (KR) 10-2022-0017700

(51) Int. Cl. B66F 3/46; E04G 11/48

(52) U.S. Cl. CPC B66F 3/46; E04G 11/48

(57) ABSTRACT

The present invention relates to an integrated lifting control system for controlling horizontal maintenance and loads of weights lifted vertically, the integrated lifting control system including: power units for supplying hydraulic or pneumatic pressures to hydraulic/pneumatic jacks as strand jacks for lifting the weights as unit weights to installation positions; the hydraulic/pneumatic jacks each having a CP block serving as a support stand and maintaining a strand wire in a vertical direction, a spherical or semispherical bearing installed on the CP block, and a load cell mounted on the strand wire to sense the loads of the weights; a main control panel connected to the power units and the hydraulic/pneumatic jacks; and a piperack connected to the strand wires of the hydraulic/pneumatic jacks.

### BACKGROUND OF THE INVENTION

Cross Reference to Related Application of the Invention

The present application claims the benefit of Korean Patent Application No. 10-2022-0017700 filed in the Korean Intellectual Property Office on Feb. 10, 2022, the entire contents of which are incorporated herein by reference.

### FIELD OF THE INVENTION

The present invention relates to an integrated lifting control system for controlling horizontal maintenance and loads of weights lifted vertically that is capable of vertically lifting the weights used in various fields such as construction, shipbuilding, and the like in a safe way and integratedly controlling the loads of the weights, and more specifically, to an integrated lifting control system for controlling horizontal maintenance and loads of weights lifted vertically that is capable of having a plurality of hydraulic/pneumatic jacks disposed correspondingly to lift point axes, power units for supplying a pneumatic or hydraulic pressure to the respective hydraulic/pneumatic jacks to allow the hydraulic/pneumatic jacks to be operable, and a main control panel (MCP) for performing synchronizing control for multiple lift points, when unit weights (modules) made as the weights are lifted and thus integratedly installed so as to reduce a period of construction in various fields such as construction, shipbuilding, and the like, wherein the hydraulic/pneumatic jacks include CP blocks disposed on lower portions thereof and serving as support stands, spherical or semispherical bearings disposed on the CP blocks to vertically lift the unit weights so that even though the unit weights are not loaded horizontally on a piperack, strand wires of the hydraulic/pneumatic jacks are always maintained vertically to allow the vertically lifted piperack on which the unit weights are loaded to be maintained horizontally, and load cells mounted onto the strand wires to transmit the loads of the unit weights locked on the strand wires to the main control panel so that the loads of the unit weights are monitored and integratedly controlled to lift the unit weights more safely.

### BACKGROUND OF THE RELATED ART

First, a conventional lifting apparatus as disclosed in Korean Patent No. 10-1424111 entitled “Floor table form lifting apparatus” (Issued on Jul. 22, 2014) will be explained below.

Together with economic growth, recently, land price increases and efficient land usage requirements are caused, and to do this, accordingly, buildings outstandingly tend to become high-rise and large-scale buildings.

Most of such buildings are notedly found in offices, large commercial aggregate buildings, apartments, and the like, and because of simplification of construction and high economic efficiencies, generally, they are built to repeated forms with the same structure as one another.

Further, such buildings require a fast construction period, and so as to satisfy such a requirement, large-sized forms or table forms are frequently used.

A floor table form, which is used to perform floor concrete casting on each floor of the building, is a large slab form made by integrating a form plate with a supporting post, a beam, a girder, and the like to move vertically and horizontally.

In the case of a method using the floor table form, a period of construction for a structure depends upon lifting time and efficiency of the floor table form.

Scaffolds (safety foot boards) used by workers are built to install various pipe facilities on a ceiling or top of a building, and each pipe facility is moved from the floor of the building above the scaffold by means of a crane or lift. Next, the pipe facilities are built by the workers located on tops of the scaffolds installed on the ceiling or top of the building, and if the installation of the pipe facilities is finished, the scaffolds are removed.

To install the various pipe facilities, accordingly, the scaffolds are temporarily installed on the ceiling or top of the building, and on the scaffolds as high-rise places, the pipe facilities are one by one installed.

In this case, however, man hour and installation cost required for temporary installation of the scaffolds are excessively increased.

After the pipe facilities have been installed, further, the removal of the scaffolds is performed at the outside, thereby causing high removal costs, and also, since the workers are located on the high-rise scaffolds during the work, they may be exposed to dangerous situations and safety accidents.

In specific, the respective pipe facilities are one by one installed on the high-rise scaffolds by means of lifting by the crane or lift, thereby extending a period of construction and substantially reducing work efficiencies.

Generally, a strand jack is used to lift all kinds of weights to installation position [symbol] in various fields such as construction, shipbuilding, and the like.

FIG. 1 shows a state where a conventional lifting apparatus 100 is installed on a structure S10, and the structure S10 includes an upper layer S11, a lower layer S12, and wall bodies S13 coupled to the upper layer S11 and the lower layer S12.

Referring to FIG. 1, the conventional lifting apparatus 100 is configured to have lugs 110 fixedly attached to a piperack module PR+P and strand jacks 120 adapted to directly lift the piperack module.

The piperack module PR+P is a module that is made by loading and modularizing heavy facilities such as pipes P, ducts, or electrical equipment onto a piperack PR.

The lugs 110 are coupled to the piperack module PR+P to fix strand wires 122 of the strand jacks 120 thereto.

The strand jacks 120 are devices for lifting the pipe-rack module PR+P through the lugs 110 in the reverse direction of gravity direction.

Each strand jack 120 has a hollow hydraulic cylinder 121, the strand wire 122 passing through the hollow center of the hydraulic cylinder 121, and a pair of clamps (not shown) mounted on one end and the other end of the hydraulic cylinder 121, respectively.

The strand jack 120 is installed with the steps of forming a hole h on the upper layer S11 of the structure S10, locating the hollow hydraulic cylinder 121 onto the upper layer S11, passing the strand wire 122 through the hole h, and coupling the strand wire 122 to the corresponding lug 110.

In installing the strand jack 120, further, a reinforcement frame 130 having a strand wire passing hole (not shown) is additionally installed between the upper layer S11 and the hydraulic cylinder 121.

In the case of the conventional lifting apparatus 100, accordingly, the work for forming the hole h on the upper layer S11 of the structure S10 such as a slab or beam has to be necessarily needed so as to lift down the strand wire 122 toward the lower layer S12.

Due to the drilling of the hole h on the upper layer S11, accordingly, the performance of the structure S10 may become deteriorated, and the finishing work of the drilled portion, that is, the hole h and the drilling work may be conflict with the construction of the upper layer S11.

Further, the strand jack 120 is a hydraulic/pneumatic jack that is designed to move up and down, without any limitation of a lift weight, and the strand wire 122 passes through the upper and lower anchors and the center holes of the strand jack 120, so that when the stroke of the jack is expanded, the strand wire 122 is gripped by the upper anchor to lift the lift weight, and when the stroke of the jack is contracted, the strand wire 122 is gripped by the lower anchor to support a state of the lift weight, thereby allowing all kinds of weights to move up and down.

However, the strand jacks 120 as the plurality of hydraulic/pneumatic jacks for lifting a heavy weight cannot be synchronizedly controlled in their multiple lift points, and further, it is impossible to synchronizedly control individual strand jacks 120, group strand jacks 120, and whole strand jacks 120.

In specific, when various weights having different sizes and shapes are lifted vertically, they are not maintained horizontally, and the loads of the weights locked onto the strand wires 122 are not integratedly controlled, so that it is hard to vertically lift and install the weights at their horizontal state, workability is greatly reduced, and safety accidents happen.

### SUMMARY OF THE INVENTION

Accordingly, the present invention has been made in view of the above-mentioned problems occurring in the related art, and it is an object of the present invention to provide an integrated lifting control system for controlling horizontal maintenance and loads of weights lifted vertically that is capable of having a plurality of hydraulic/pneumatic jacks disposed correspondingly to lift point axes, power units for supplying a pneumatic or hydraulic pressure to the respective hydraulic/pneumatic jacks to allow the hydraulic/pneumatic jacks to be operable, and a main control panel (MCP) for performing synchronizing control for multiple lift points, when unit weights (modules) made as installation weights are lifted and thus integratedly installed so as to reduce a period of construction in various fields such as construction, shipbuilding, and the like, wherein the hydraulic/pneumatic jacks include CP blocks disposed on lower portions thereof and serving as support stands, spherical or semispherical bearings disposed on the CP blocks to vertically lift the unit weights so that even though the unit weights are not loaded horizontally on a piperack, strand wires of the hydraulic/pneumatic jacks are always maintained vertically to allow the vertically lifted piperack on which the unit weights are loaded to be maintained horizontally, and load cells located on the strand wires of the hydraulic/pneumatic jacks to transmit the loads of the unit weights locked on the strand wires to the main control panel so that the loads of the unit weights are monitored and integratedly controlled to lift the unit weights more safely.

To accomplish the above-mentioned objects, according to the present invention, there is provided an integrated lifting control system for controlling horizontal maintenance and loads of weights to thus vertically lift the weights used in various fields such as construction, shipbuilding, and the like and to integratedly control the loads of the weights, the integrated lifting control system comprising: power units for supplying hydraulic or pneumatic pressures to hydraulic/pneumatic jacks as strand jacks for lifting the weights as unit weights to installation positions; the hydraulic/pneumatic jacks disposed on tops of the power units to operate with the hydraulic or pneumatic pressures supplied from the power units, each hydraulic/pneumatic jack having a CP block serving as a support stand and maintaining a strand wire in a vertical direction, a spherical or semispherical bearing installed on the CP block, and a load cell mounted on the strand wire to sense the loads of the weights; a main control panel connected to the power units and the hydraulic/pneumatic jacks to receive the rotations of the spherical or semispherical bearings and the loads of the unit weights locked onto the strand wires and to perform monitoring and integrated control for the loads of the unit weights; and a piperack connected to the strand wires of the hydraulic/pneumatic jacks to load the unit weights lifted vertically thereon, the integrated lifting control system provided by a lifting method including the steps of: (S1) installing the power units for supplying hydraulic or pneumatic pressures to the hydraulic/pneumatic jacks; (S2) installing the hydraulic/pneumatic jacks on tops of the power units by inserting the spherical or semispherical bearings into the CP blocks as support stands disposed on the outsides of the power units and mounting the load cells onto the strand wires; (S3) connecting the power units and the hydraulic/pneumatic jacks to the main control panel by means of cables to check whether values sensed on lift points of the hydraulic/pneumatic jacks are normally obtained and the strand wires of the hydraulic/pneumatic jacks are maintained vertically; (S4) sensing the loads of the unit weights by means of the load cells when the hydraulic or pneumatic pressures are introduced into the hydraulic/pneumatic jacks from the power units to vertically lift the unit weights and maintaining the strand wires vertically by means of the spherical or semispherical bearings to allow the unit weights to be vertically lifted at horizontal levels; and (S5) performing synchronizing control for the hydraulic/pneumatic jacks in the range of ±5 to 20 mm per lift point according to lifting conditions (the load of each unit weight, the pressure value of the unit weight, the strand wire lengths, the lifting height, and the horizontal state of the unit weight) of the unit weights on the main control panel to thus lift up the unit weights vertically.

### BRIEF DESCRIPTION OF THE DRAWINGS

The above and other objects, features and advantages of the present invention will be apparent from the following detailed description of the embodiments of the invention in conjunction with the accompanying drawings, in which:

FIG. 1 is a schematic view showing a state where a conventional lifting apparatus is installed on a structure;

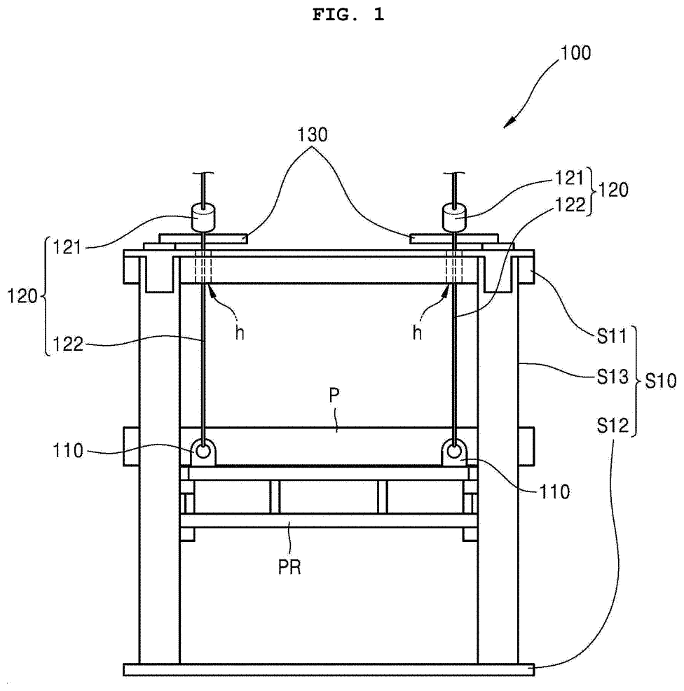

FIG. 2 is a perspective view showing an integrated lifting control system according to the present invention;

FIG. 3 is a front view showing hydraulic/pneumatic jacks of the integrated lifting control system according to the present invention;

FIG. 4 is a sectional view showing a state where a spherical or semispherical bearing is disposed on a support stand and the hydraulic/pneumatic jack of the integrated lifting control system according to the present invention;

FIG. 5 is a perspective view showing a pressure sensor disposed on the hydraulic/pneumatic jack of the integrated lifting control system according to the present invention;

FIG. 6 is a perspective view showing a wire sensor disposed on the hydraulic/pneumatic jack and an operating state thereof;

FIG. 7 is a perspective view showing a laser sensor disposed on a lifting module and an operating state thereof; and

FIG. 8 is a flowchart showing the integrated lifting control system according to the present invention provided by a lifting method including the steps S1 to S5.

### DETAILED DESCRIPTION OF THE PREFERRED EMBODIMENT

Hereinafter, an explanation of an integrated lifting control system for controlling horizontal maintenance and loads of weights lifted vertically according to the present invention will be given in detail with reference to the attached drawings.

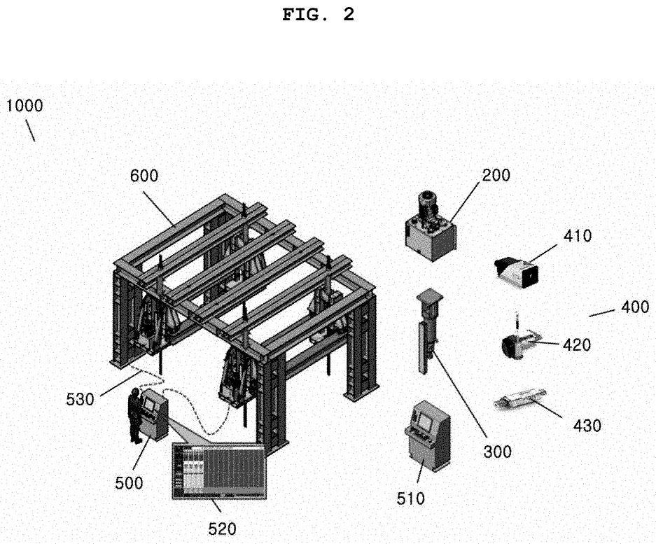

FIG. 2 shows an integrated lifting control system for lifting a unit weight (module) according to the present invention.

A plurality of hydraulic/pneumatic jacks is provided correspondingly to lift point axes, and power units are provided to supply a pneumatic or hydraulic pressure to the corresponding hydraulic/pneumatic jacks.

Each hydraulic/pneumatic jack is operable if it receives the pneumatic or hydraulic pressure from the corresponding power unit. Further, a main control panel (MCP) is made to perform synchronizing control for multiple lift points. Accordingly, the integrated lifting control system according to the present invention is capable of performing the synchronizing control of the hydraulic/pneumatic jacks individually, by group, and wholly.

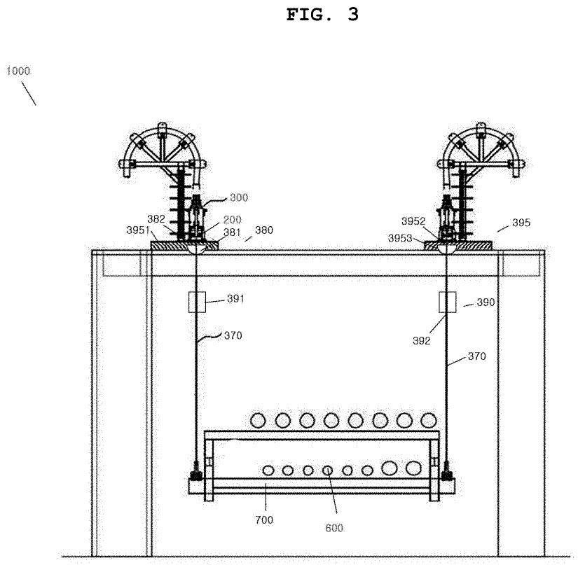

Referring to FIG. 3, spherical or semispherical bearings are installed on CP blocks serving as support stands for supporting the hydraulic/pneumatic jacks and maintaining strand wires in vertical directions, and as the spherical or semispherical bearings rotatingly move, the strand wires are maintained in the vertical directions, so that even though unit weights (modules) loaded on a piperack (PR) are not located horizontally, the piperack onto which the unit weights lifted vertically are loaded can be maintained horizontally.

Further, load cells are located on the strand wires of the hydraulic/pneumatic jacks to transmit the loads of the weights locked on the strand wires to the main control panel.

The present invention relates to an integrated lifting control system 1000 for controlling horizontal maintenance and loads of weights lifted vertically that is capable of vertically lifting the weights used in various fields such as construction, shipbuilding, and the like in a safe way and integratedly controlling the loads of the weights.

To do this, the integrated lifting control system 1000 according to the present invention includes: power units 200 disposed on the undersides of a plurality of hydraulic/pneumatic jacks 300 for lifting unit weights (modules) 600 to installation positions and serving as hydraulic/pneumatic pumps for uniformly supplying a hydraulic or pneumatic pressure to the plurality of hydraulic/pneumatic jacks 300; the plurality of hydraulic/pneumatic jacks 300 disposed on tops of the power units 200 to be operable with the hydraulic or pneumatic pressure supplied from the power units 200, each hydraulic/pneumatic jack 300 having a CP block 395 serving as a support stand thereof and to maintain a vertical direction of a strand wire 370, a spherical or semispherical bearing 380 disposed on the CP block 395, and a load cell 390 mounted on the strand wire 370 to sense loads of the unit weights 600; a sensor part 400 having a pressure sensor 410 adapted to sense a pressure supplied to each hydraulic/pneumatic jack 300, a wire sensor 420 adapted to sense a displacement length of each strand wire 370, which are disposed on the outer surface of each hydraulic/pneumatic jack 300, and a laser sensor 430 adapted to sense a lifted height and a horizontal state of each unit weight, which is disposed on the outer surface of the unit weight; a main control panel 500 connected to the power units 200 and the hydraulic/pneumatic jacks 300 and adapted to receive the rotational movements (rotations) of the spherical or semispherical bearings 380 and the loads of the unit weights 600 locked onto the strand wires 370 to thus carry out monitoring and integral control for the loads of the unit weights 600; and a piperack 700 connected to the strand wires 370 of the hydraulic/pneumatic jacks 300 to load the unit weights 600 lifted vertically thereon.

As shown in FIGS. 2 and 3, the power units 200 are disposed on the undersides of the plurality of hydraulic/pneumatic jacks 300 for lifting the unit weights 600 to installation positions and serve as the hydraulic/pneumatic pumps for uniformly supplying the hydraulic or pneumatic pressure to the plurality of hydraulic/pneumatic jacks 300.

In specific, each power unit 200 includes a body 210 made of a metal material, a hydraulic/pneumatic pressure inlet hole 220 serving as an open hole for supplying the hydraulic or pneumatic pressure to the interior of a body 310 of the hydraulic/pneumatic jack 300 disposed on top of the body 210, a press line 230 disposed inside the body 210 to control the supply of the hydraulic or pneumatic pressure to the hydraulic/pneumatic jack 300, and bolt fastening holes 240 formed on top of the body 210 and fastened to the body 310 of the hydraulic/pneumatic jack 300 by means of fastening members such as bolts. In this case, the press line 230 and the main control panel 500 are connected to each other by means of a cable 530.

The hydraulic or pneumatic pressure is controlled according to a pressure value inputted to the press line 230 from the main control panel 500, and through the pressure value inputted to the press line 230 from the main control panel 500, accordingly, the power unit 200 uniformly supplies the hydraulic or pneumatic pressure to the hydraulic/pneumatic jack 300.

According to the present invention, further, the power units 200 as the hydraulic/pneumatic pumps connected to the main control panel 500 allow the hydraulic or pneumatic pressure to be introduced uniformly into the hydraulic/pneumatic jacks 300, so that the hydraulic/pneumatic jacks 300 can lift the unit weights 600 safely and easily.

Each hydraulic/pneumatic jack 300 is disposed on top of the power unit 200 and thus operates with the hydraulic or pneumatic pressure supplied from the power unit 200.

In specific, each hydraulic/pneumatic jack 300 includes the body 310 made of a metal material, a press line 320 disposed on top of the body 310 to introduce the hydraulic or pneumatic pressure from the power unit 200, a cylinder 330 disposed on the outside of the press line 320 to move up and down the unit weights 600, a pressure sensor mounting member 340 and a wire sensor mounting member 350 disposed on the outer surface of the body 310 to mount the pressure sensor 410 for sensing the pressure supplied to each hydraulic/pneumatic jack 300 and the wire sensor 420 for sensing the displacement length of the strand wire 370, and bolt fastening holes 360 formed on the underside of the body 310 and fastened to the bolt fastening holes 240 of the power unit 200. In this case, the press line 320 and the main control panel 500 are connected to each other by means of a cable 530, and accordingly, the hydraulic or pneumatic pressure introduced into the press line 320 can be controlled.

In more specific, each hydraulic/pneumatic jack 300 further includes the CP block 395 serving as the support stand for maintaining the vertical direction of the strand wire 370, the spherical or semispherical bearing 380 disposed on the CP block 395, and the load cell 390 mounted on the outer surface of the strand wire 370 to sense the loads of the unit weights 600.

Further, the CP block 395 includes a body 3951, a through hole 3952 formed at the center of the body 3951 to pass the strand wire 370 therethrough, and a concave insertion groove 3954 or an insertion groove 3953 formed on top or underside of the body 3951 to insert the spherical or semispherical bearing 380 thereinto.

The spherical or semispherical bearing 380 includes a body 381 as a spherical or semispherical bearing and a wire mounting hole 382 formed on the center of the body 381 to mount the strand wire 370 therealong, and as the spherical or semispherical bearing 380 on which the strand wire 370 is mounted rotates in left and right sides, accordingly, the vertical state of the strand wire 370 can be maintained.

In specific, the body 381 of the spherical or semispherical bearing 380 is connected to the main control panel 500 by means of a cable 530, and through positive and negative power sources supplied to the body 381, the body 381 of the spherical or semispherical bearing 380 rotates in left and right sides to thus maintain the vertical state of the strand wire 370, so that even though the unit weights 600 are not loaded horizontally on the piperack 700, while the piperack 700 vertically lifted is being maintained horizontally, the piperack 700 on which the unit weights 600 are loaded can be lifted vertically more safely.

Each load cell 390 includes a body 391 having an elastic body as a resistance sensor whose sectional area and length are varied by the loads of the unit weights 600 and a plurality of strain gauges for converting a varied value of the elastic body into an electrical resistance value and a wire mounting hole 392 formed at the center of the body 391 to mount the strand wire 370 thereonto.

The bodies 391 of the load cells 390 are connected to the main control panel 500 by means of cables, and accordingly, the loads of the unit weights 600 locked onto the strand wires 370 are transmitted to the main control panel 500, so that the loads of the unit weights 600 can be monitored and integratedly controlled, thereby performing the lifting work more safely.

Accordingly, the hydraulic/pneumatic jacks 300 are configured to allow the hydraulic or pneumatic pressures to be introduced into the press lines 320 of the bodies 310 from the power units 200 connected to the main control panel 500, and the hydraulic or pneumatic pressures introduced are sensed by means of the pressure sensors 410 disposed on the outer surfaces of the hydraulic/pneumatic jacks 300. Further, the press lines 320 of the hydraulic/pneumatic jacks 300 and the main control panel 500 are connected to one another by means of the cables 530, and accordingly, the hydraulic or pneumatic pressures introduced into the press lines 320 are controllable by means of the main control panel 500.

Further, the cylinders 330 of the hydraulic/pneumatic jacks 300 uniformly move up and down, thereby performing the lifting work of the unit weights 600 more safely and easily.

In specific, the spherical or semispherical bearings 380 are disposed on the CP blocks 395 serving as the support stands for supporting the hydraulic/pneumatic jacks 300 and maintaining the vertical directions of the strand wires 370, and accordingly, the spherical or semispherical bearings 380 on which the strand wires 370 are mounted rotate in left and right sides, thereby maintaining the vertical directions of the strand wires 370.

In this case, even though the unit weights 600 are not loaded horizontally on the piperack 700, the strand wires 370 are always maintained vertically, and accordingly, the piperack 700 vertically lifted can be maintained horizontally so that the piperack 700 on which the unit weights 600 are loaded can be lifted vertically in a safe way.

Even in the case where the ground (floor) on a construction site is not flat, the spherical or semispherical bearings 380 disposed on the CP blocks 395 serving as the support stands rotate in left and right sides, and accordingly, the power units 200 and the hydraulic/pneumatic jacks 300 disposed on tops of the CP blocks 395 are maintained horizontally, without being inclined in any one side, thereby allowing the piperack 700 on which the unit weights 600 are loaded to be lifted vertically more safely.

Further, each load cell 390 of the hydraulic/pneumatic jacks 300 is configured to have the body 391 having the elastic body as the resistance sensor whose sectional area and length are varied by the loads of the unit weights 600 and the plurality of strain gauges for converting a varied value of the elastic body into the electrical resistance value and the wire mounting hole 392 formed at the center of the body 391 to mount the strand wire 370 thereonto, and accordingly, the load cells 390 are mounted on the strand wires 370 and connected to the main control panel 500, so that the loads of the unit weights 600 locked onto the strand wires 370 are transmitted to the main control panel 500, thereby allowing the loads of the unit weights 600 to be monitored and integratedly controlled to thus perform the lifting work more safely.

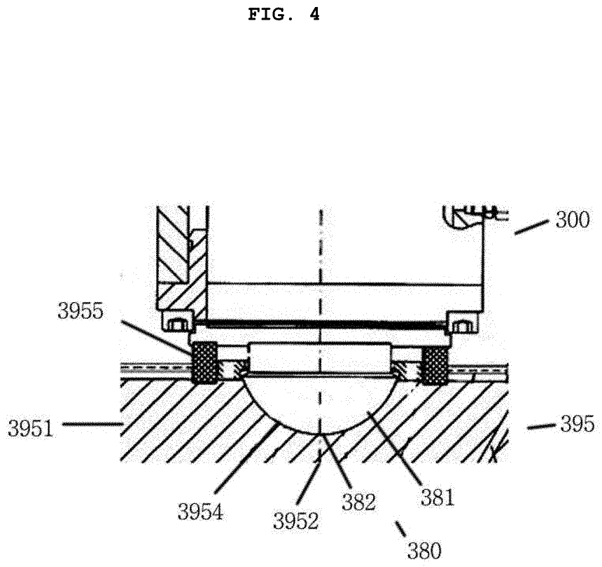

As shown in FIG. 4, each CP block 395 as the support stand includes the body 3951 and the concave insertion groove 3954 formed on top of the body 3951 to insert the spherical or semispherical bearing 380 thereinto, so that the spherical or semispherical bearing 380 is inserted into the concave insertion groove 3954 of the CP block 395 and rotates in left and right sides, and further, each CP block 395 has a fastener 3955 adapted to fasten the underside of the hydraulic/pneumatic jack 300 thereto.

Accordingly, the spherical or semispherical bearings 380, which are inserted into the concave insertion grooves 3954 of the bodies 3951 slant according to an inclination of the ground (floor) on the construction site, rotate in left and right sides to support the power units 200 and the hydraulic/pneumatic jacks 300 disposed on tops of the CP blocks 395, so that the power units 200 and the hydraulic/pneumatic jacks 300 are maintained horizontally to allow the piperack 700 on which the unit weights 600 are loaded to be lifted vertically more safely.

If necessary, each CP block 395 has the through hole 3952 formed at the bottom of the body 3951 to pass the strand wire 370 therethrough and a hinge insertion hole formed inside the through hole 3952, and further, the body 381 of the spherical or semispherical bearing 380 has a hinge shaft and a hinge insertion hole correspondingly coupled to the hinge insertion hole formed inside the through hole 3952. As a result, a hinge passes through the hinge insertion hole formed inside the through hole 3952 of the CP block 395 and the hinge insertion hole of the spherical or semispherical bearing 380 and is fastened to them.

Otherwise, the spherical or semispherical bearing 380 may be replaced with bearings having other shapes.

Of course, the left and right rotations of the bodies 381 of the spherical or semispherical bearings 380 connected to the main control panel 500 may be controlled manually.

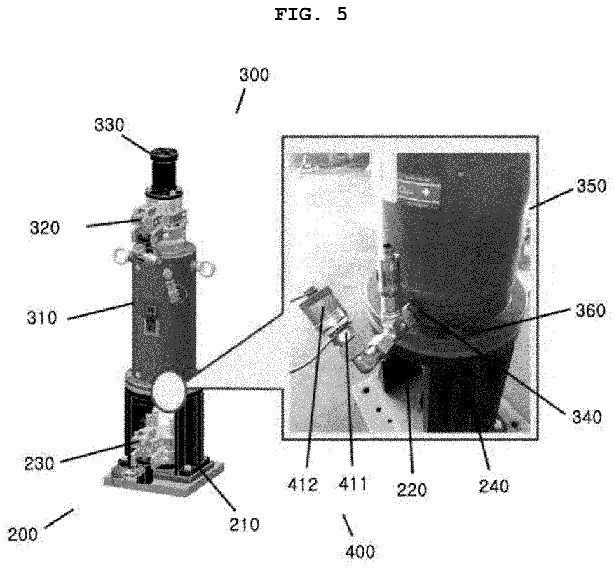

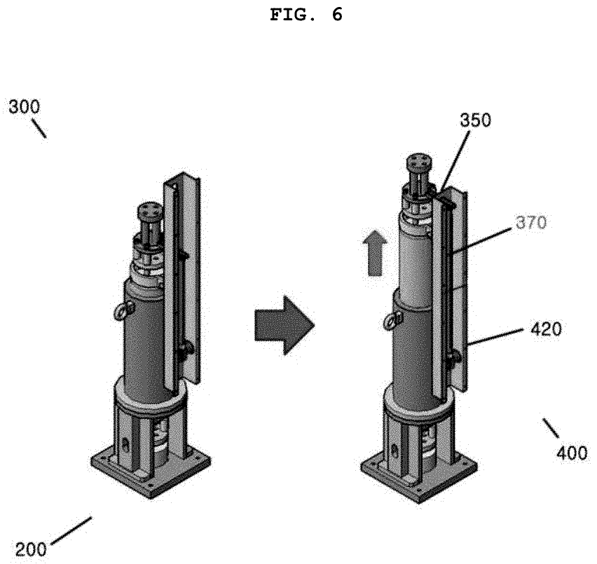

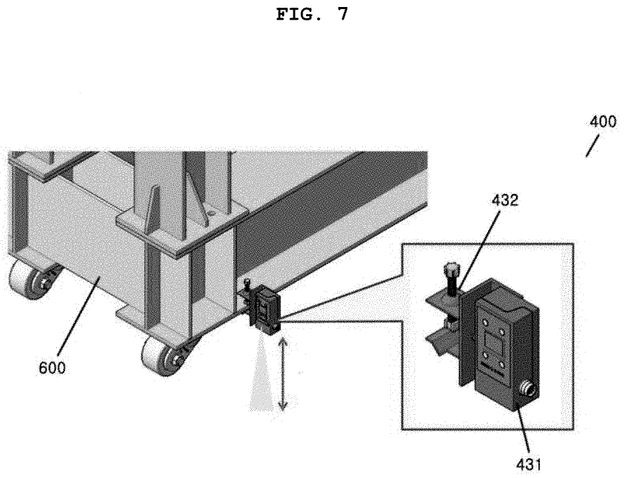

FIG. 5 is a perspective view showing a pressure sensor disposed on the hydraulic/pneumatic jack of the integrated lifting control system according to the present invention, FIG. 6 is a perspective view showing a wire sensor disposed on the hydraulic/pneumatic jack and an operating state thereof, and FIG. 7 is a perspective view showing a laser sensor disposed on the unit weight and an operating state thereof.

As shown in FIGS. 5 to 7, the sensor unit 400 has three sensors per lift point (axis) so that the synchronizing control for the lift points can be performed, and as mentioned above, the three sensors of the sensor unit 400 per lift point include the pressure sensor 410, the wire sensor 420, and the laser sensor 430.

In specific, the pressure sensor 410 serves to measure the load per lift point, the wire sensor 420 serves to measure an amount of stroke varied of the hydraulic/pneumatic jack 300, and the laser sensor 430 serves to determine lifting heights and horizontal control of the unit weights 600.

The pressure sensor 410 includes a body 411 made of a metal material and mounted onto the pressure sensor mounting member 340 of the hydraulic/pneumatic jack 300 to sense the pressure supplied to the hydraulic/pneumatic jack 300 and a sensor 412 disposed on the outer surface of the body 411. Accordingly, the body 411 is mounted onto the pressure sensor mounting member 340 of the hydraulic/pneumatic jack 300, and the pressure sensor 410 converts the load locked onto the hydraulic/pneumatic jack 300 into tons through the input value to the press line 320 of the hydraulic/pneumatic jack 300 and checks whether the converted tons are close to an expected load value in real lifting work to the maximum.

The wire sensor 420 is mounted onto the wire sensor mounting member 350 of the hydraulic/pneumatic jack 300 to sense the displacement length of the strand wire 370, and when the hydraulic/pneumatic jack 300 moves up, accordingly, the length of the wire sensor 420 is varied, so that the varied value as an analog signal is transmitted to a control program of the main control panel 500.

In this case, the varied value of the length of the wire sensor 420 is the same as that of the stroke of the hydraulic/pneumatic jack 300.

Accordingly, the wire sensor 420 is provided to measure the varied value of the stroke of the hydraulic/pneumatic jack 300, and then, a parameter (an amount of stroke varied) is checked to perform fine individual or group synchronizing control.

The laser sensor 430 includes a body 431 for sensing the lifting height and horizontal control of the unit weight 600 and a clamp jig 432 fixed to the outer surface of the unit weight 600, so that the laser sensor 430 can be detachably mounted on all positions of the unit weight 600.

The laser sensor 430 serves to measure the lifted height of the unit weight 600 and check whether the unit weight 600 is lifted horizontally in a safe manner.

The main control panel 500 is connected to the power units 200, the spherical or semispherical bearings 380 of the hydraulic/pneumatic jacks 300, the load cells 390, and the pressure sensors 410, the wire sensors 420, and the laser sensors 430 of the sensor unit 400 and serves as a controller for controlling the loads of the unit weights 600, the pressure values, the strand wire lengths, the lifting heights, and the horizontal states, while the unit weights are being lifted.

The main control panel 500 has a body 510 connected to the power units 200, the spherical or semispherical bearings 380 and the load cells 390 of the hydraulic/pneumatic jacks 300, and the pressure sensors 410, the wire sensors 420, and the laser sensors 430 of the sensor unit 400 by means of the cables 530 and a monitor 520 disposed on the upper portion of the body 510 to monitor the corresponding values during the lifting of the unit weights 600. Accordingly, the integrated lifting control system according to the present invention can perform the synchronizing control in the range of ±5 to 20 mm per lift point while the unit weights 600 are being lifted.

To achieve the objects of the present invention and provide the effective advantages of the present invention, accordingly, the integrated lifting control system 1000 according to the present invention is configured to have the hydraulic/pneumatic jacks 300 disposed on the lift points (axes) and the power units 200 disposed on the undersides of the hydraulic/pneumatic jacks 300 to supply the hydraulic or pneumatic pressures to the hydraulic/pneumatic jacks 300, so that if the hydraulic or pneumatic pressures are supplied from the power units 200 to the hydraulic/pneumatic jacks 300, the hydraulic/pneumatic jacks 300 can operate. Further, the main control panel 500 is provided to perform the synchronizing control for the multiple lift points.

In specific, the power units 200 are disposed on the undersides of the hydraulic/pneumatic jacks 300 for lifting the unit weights 600 to an installation position and serve as hydraulic/pneumatic pumps for uniformly supplying the hydraulic or pneumatic pressures to the hydraulic/pneumatic jacks 300.

In specific, the main control panel 500 is connected to the pressure sensors 410, the wire sensors 420, and the laser sensors 430 of the sensor unit 400 and serves as the controller for controlling the pressures of the unit weights 600 during the lifting, the displacement lengths of the strand wires 370, and the lifting height.

Further, even though the unit weights 600 are not loaded horizontally on the piperack 700, the piperack 700 on which the unit weights 600 lifted vertically are loaded can be maintained horizontally during the vertical lifting, thereby ensuring more safe lifting.

To monitor and integratedly control the loads of the unit weights locked onto the strand wires 370 of the hydraulic/pneumatic jacks 300 and thus to perform the lifting work more safely, further, the integrated lifting control system 1000 according to the present invention is configured to have the spherical or semispherical bearings 380 disposed on the CP blocks 395 serving as the support stands for supporting the hydraulic/pneumatic jacks 300 and maintaining the vertical directions of the strand wires 370, so that the spherical or semispherical bearings 380 on which the strand wires 370 are mounted rotate in left and right sides, thereby maintaining the vertical directions of the strand wires 370.

In this case, even though the unit weights 600 are not loaded horizontally on the piperack 700, the strand wires 370 are always maintained vertically, and accordingly, the piperack 700 vertically lifted can be maintained horizontally. Further, even in the case where the ground on the construction site is not flat, the hydraulic/pneumatic jacks 300 are maintained horizontally, and accordingly, the piperack 700 on which the unit weights 600 are loaded can be lifted vertically more safely.

Further, the integrated lifting control system 1000 according to the present invention is configured to have the load cells 390 with the body 391 and the wire mounting hole 392 formed at the center of the body 391 to mount the strand wire 370 thereonto, and accordingly, the loads of the unit weights 600 locked onto the strand wires 370 are transmitted to the main control panel 500, so that the loads of the unit weights 600 can be monitored and integratedly controlled, thereby performing the lifting work more safely.

Moreover, the integrated lifting control system 1000 according to the present invention is capable of vertically lifting the unit weights 600 and horizontally moving the unit weights 600.

If necessary, in specific, the hydraulic or pneumatic pressures not controlled are supplied to the press lines 320 of the hydraulic/pneumatic jacks 300 from the power units 200 connected to the main control panel 500, and the hydraulic or pneumatic pressures introduced into the press lines 320 of the hydraulic/pneumatic jacks 300 are controlled on the main control panel 500 through the pressure values inputted to the press lines 320 of the hydraulic/pneumatic jacks 300, so that the cylinders 330 of the hydraulic/pneumatic jacks 300 uniformly move up and down by means of the uniform hydraulic or pneumatic pressures according to the pressure values inputted to the press lines 320 from the main control unit 500.

Accordingly, the integrated lifting control system 1000 according to the present invention is technically configured to have the spherical or semispherical bearings 380 disposed on the CP blocks 395 serving as the support stands for supporting the hydraulic/pneumatic jacks 300 to vertically lift the unit weights so that the vertical directions of the strand wires 370 can be maintained by means of the left and right rotations of the spherical or semispherical bearings 380 on which the strand wires 370 are mounted and even though the unit weights 600 are not loaded horizontally on the piperack 700, the piperack 700 on which the unit weights 600 are loaded can be lifted vertically more safely, while the strand wires 370 are being always maintained vertically, technically configured to allow the spherical or semispherical bearings 380 disposed on the CP blocks 395 serving as the support stands even in the case where the ground (floor) on a construction site is not flat to rotate in left and right sides, so that the hydraulic/pneumatic jacks 300 disposed on tops of the CP blocks 395 are maintained horizontally, without being inclined in any one side, thereby allowing the piperack 700 on which the unit weights 600 are loaded to be vertically lifted more safely, and technically configured to have the main control panel 500 connected to the power units 200, the hydraulic/pneumatic jacks 300, and the pressure sensors 410, the wire sensors 420, and the laser sensors 430 of the sensor unit 400 to perform the synchronizing control of the multiple lift points of the unit weights, thereby performing the synchronizing control of the hydraulic/pneumatic jacks individually, by group, and wholly, whereby various weights (modules) having different sizes and shapes may be easily lifted and installed, while they are lifted vertically and moved horizontally, period of construction and installation cost may be reduced, workability may be greatly improved, and safety accidents may be prevented.

Hereinafter, a lifting method, which is performed by the integrated lifting control system 1000 for controlling horizontal maintenance and loads of the weights lifted vertically according to the present invention, will be explained.

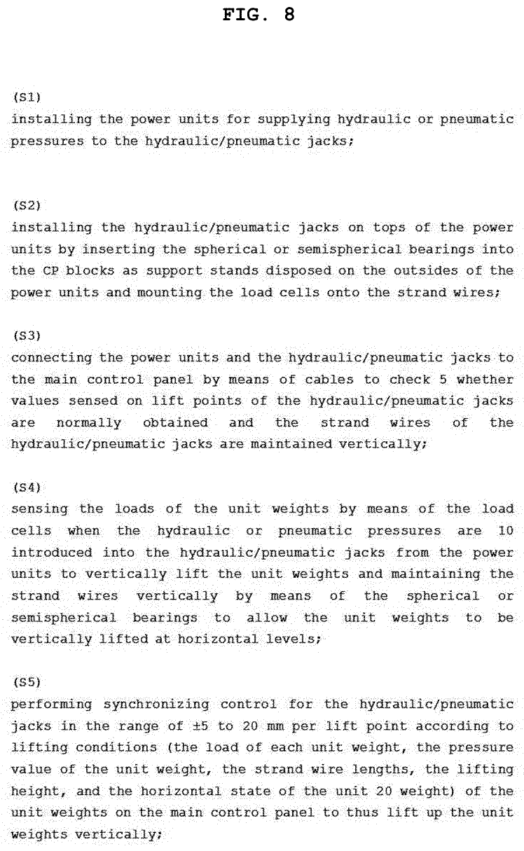

FIG. 8 is a flowchart showing a lifting method including the steps S1 to S5 performed by the integrated lifting control system 1000 according to the present invention (See FIGS. 2 to 7 showing the integrated lifting control system 1000).

The lifting method that is performed by the integrated lifting control system 1000 for controlling horizontal maintenance and loads of the weights lifted vertically according to the present invention includes the steps S1 to S5 as will be discussed below to thus lift the weights (modules) upward.

The lifting method according to the present invention includes: the step S1 of installing the power units for supplying hydraulic or pneumatic pressures to the hydraulic/pneumatic jacks; the step S2 of installing the hydraulic/pneumatic jacks on tops of the power units by inserting the spherical or semispherical bearings into the CP blocks as support stands disposed on the outsides of the power units and mounting the load cells onto the strand wires; the step S3 of connecting the power units and the hydraulic/pneumatic jacks to the main control panel by means of cables to check whether values sensed on lift points of the hydraulic/pneumatic jacks are normally obtained and the strand wires of the hydraulic/pneumatic jacks are maintained vertically; the step S4 of sensing the loads of the unit weights by means of the load cells when the hydraulic or pneumatic pressures are introduced into the hydraulic/pneumatic jacks from the power units to vertically lift the unit weights and maintaining the strand wires vertically by means of the spherical or semispherical bearings to allow the unit weights to be vertically lifted at horizontal levels; and the step S5 of performing synchronizing control for the hydraulic/pneumatic jacks in the range of ±5 to 20 mm per lift point according to lifting conditions (the load of each unit weight, the pressure value of the unit weight, the strand wire lengths, the lifting height, and the horizontal state of the unit weight) of the unit weights on the main control panel to thus lift up the unit weights vertically.

According to the present invention, before the step S1, the lifting method further includes: the step S11 of building the unit weights on the ground of a weight installation region or integratedly building the unit weights on a separate fabrication place to transfer the built unit weights to the ground of the weight installation region by means of a self propelled modular transporter (SPMT); the step S12 of installing connecting pieces onto pad eyes pre-disposed on beams of the weight installation region and mounting the strand wires onto the connecting pieces; and the step S13 of installing loading beams for supporting the integrated weights during lifting and jigs for performing the lifting on the undersides of the integrated weights and passing the strand wires through the hydraulic/pneumatic jacks, and after the step S5, the lifting method further includes: the step S51 of fixedly installing the weights lifted up through the steps S1 to S4 on installation positions by means of bolting or welding performed by a worker on a lift; and the step S52 of removing the loading beams and the jigs and separating the integrated lifting control system including the hydraulic/pneumatic jacks in the reverse order of the installation to organize the weight installation region.

Through the step S2, the lifting method according to the present invention is performed to allow the spherical or semispherical bearings 380 disposed on the CP blocks 395 to be located on the undersides of the hydraulic/pneumatic jacks 300 serving as the vertical lifting devices for the unit weights and thus connected to the main control panel 500, so that the left and right rotations of the spherical or semispherical bearings 380 are controlled by the main control panel 500, and even though the unit weights 600 are not loaded horizontally on the piperack 700, accordingly, the strand wires 370 are always maintained vertically by means of the left and right rotations of the spherical or semispherical bearings 380 to allow the piperack 700 vertically lifted and the hydraulic/pneumatic jacks to be maintained horizontally to lift the piperack 700 on which the weights 600 are loaded vertically more safely. Further, through the step S2, the load cells 390 are mounted on the strand wires 370 and connected to the main control panel 500, so that the loads of the unit weights 600 locked onto the strand wires 370 are transmitted to the main control panel 500 to thus carry out monitoring and integral control for the loads of the unit weights 600, thereby performing the lifting work more safely.

At the steps S1 to S5, the power units 200, the hydraulic/pneumatic jacks 300, and the pressure sensors 410, the wire sensors 420, and the laser sensors 430 of the sensor unit 400 are connected to the main control panel 500 and controlled by the main control panel 500, thereby performing the synchronizing control for the hydraulic/pneumatic jacks capable of synchronizedly controlling the multiple lift points of the unit weights individually, by group, and wholly, and moreover, the lifting method according to the present invention is performed to allow various weights (modules) having different sizes and shapes to be easily lifted and installed, while the weights are being lifted vertically and moved horizontally. Further, the lifting method according to the present invention is performed to reduce a period of construction and an installation cost, to greatly improve workability, and to prevent safety accidents.

Further, through the steps S11 to S13 before the step S1, the pre-work for lifting the weights is finished.

Through the steps S51 and S52 after the step S5, in addition, the weights are fixedly installed on the installation position thereof, the loading beams and the jigs are removed, and the integrated lifting control system including the hydraulic/pneumatic jacks are disassembled in the reverse order of the installation to organize the weight installation region.

Moreover, the lifting method according to the present invention is performed to allow the unit weights to be lifted vertically as well as to move horizontally.

As set forth in the foregoing, the integrated lifting control system according to the present invention has the following advantages:

Firstly, the spherical or semispherical bearings are disposed on the CP blocks serving as the support stands for supporting the hydraulic/pneumatic jacks to vertically lift the unit weights so that the vertical directions of the strand wires can be maintained by means of the left and right rotations of the spherical or semispherical bearings on which the strand wires are mounted and even though the unit weights are not loaded horizontally on the piperack, the strand wires are always maintained vertically to allow the piperack on which the unit weights lifted vertically are loaded to be maintained horizontally.

Secondly, the load cells are located on the strand wires of the hydraulic/pneumatic jacks to transmit the loads of the unit weights locked on the strand wires to the main control panel so that the loads of the unit weights can be monitored and integratedly controlled to easily lift the unit weights.

Thirdly, the hydraulic/pneumatic jacks capable of performing synchronizing control of the multiple lift points of the unit weights can be synchronizedly controlled individually, by group, and wholly.

Fourthly, various weights (modules) having different sizes and shapes can be easily lifted and installed.

Fifthly, the weights can be lifted vertically and moved horizontally.

Sixthly, the period of construction and installation cost can be reduced.

Lastly, workability can be greatly improved and safety accidents can be prevented.

The present invention may be modified in various ways and may have several exemplary embodiments. It is therefore intended that the scope of the invention be limited not by this detailed description, but rather by the claims appended hereto, and it should be understood that the invention covers all the modifications, equivalents, and replacements within the idea and technical scope of the invention.

1. An integrated lifting control system for controlling horizontal maintenance and loads of weights to thus vertically lift the weights used in various fields such as construction, shipbuilding, and the like and to integratedly control the loads of the weights, the integrated lifting control system comprising:
power units for supplying hydraulic or pneumatic pressures to hydraulic/pneumatic jacks as strand jacks for lifting the weights as unit weights to installation positions;
the hydraulic/pneumatic jacks disposed on tops of the power units to operate with the hydraulic or pneumatic pressures supplied from the power units, each hydraulic/pneumatic jack having a CP block serving as a support stand and maintaining a strand wire in a vertical direction, a spherical or semispherical bearing installed on the CP block, and a load cell mounted on the strand wire to sense the loads of the weights;
a main control panel connected to the power units and the hydraulic/pneumatic jacks to receive the rotations of the spherical or semispherical bearings and the loads of the unit weights locked onto the strand wires and to perform monitoring and integrated control for the loads of the unit weights; and
a piperack connected to the strand wires of the hydraulic/pneumatic jacks to load the unit weights lifted vertically thereon.

2. The integrated lifting control system according to claim 1, wherein the load cell of each hydraulic/pneumatic jack comprises:
a body having an elastic body as a resistance sensor whose sectional area and length are varied by the loads of the unit weights and a plurality of strain gauges for converting a varied value of the elastic body into an electrical resistance value; and
a wire mounting hole formed at the center of the body to mount the strand wire thereinto,
whereby the body of the load cell is mounted onto the strand wire and connected to the main control panel by means of a cable.

3. The integrated lifting control system according to claim 1, wherein the CP block as the support stand comprises:
a body;
a semispherical concave insertion groove formed on top of the body to insert the spherical or semispherical bearing thereinto and to thus rotate in left and right sides; and
a fastener adapted to fasten the body to the underside of the hydraulic/pneumatic jack, and otherwise,
the CP block comprises a hinge insertion hole formed on an insertion groove formed on the underside of the body to insert the spherical or semispherical bearing, and the spherical or semispherical bearing comprises a body having a hinge shaft and a hinge insertion hole correspondingly coupled to the hinge insertion hole formed inside the insertion groove formed on the underside of the body of the CP block, so that a hinge passes through the hinge insertion hole formed inside the insertion groove of the CP block and the hinge insertion hole of the spherical or semispherical bearing and is fastened to the CP block and the spherical or semispherical bearing.

4. The integrated lifting control system according to claim 3, wherein the hydraulic/pneumatic jacks are disposed on tops of the power units to operate with the hydraulic or pneumatic pressures supplied from the power units, each hydraulic/pneumatic jack comprising:
a body made of a metal material;
a press line disposed on top of the body to introduce the hydraulic or pneumatic pressure from the corresponding power unit and connected to the main control panel by means of a cable;
a cylinder disposed on the outside of the press line to move up and down the unit weights;
a pressure sensor mounting member and a wire sensor mounting member disposed on the outer surface of the body to mount a pressure sensor for sensing the pressure supplied to each hydraulic/pneumatic jack and a wire sensor for sensing the displacement length of the strand wire; and
bolt fastening holes formed on the underside of the body and fastened to bolt fastening holes of the power unit.

5. The integrated lifting control system according to claim 1, further comprising:
a pressure sensor having a body made of a metal material and mounted onto the pressure sensor mounting member of the hydraulic/pneumatic jack to sense the pressure supplied to the hydraulic/pneumatic jack and a sensor disposed on the outer surface of the body;
a wire sensor mounted onto the wire sensor mounting member of the hydraulic/pneumatic jack to sense the displacement length of the strand wire when the hydraulic/pneumatic jack moves up and to thus measure the displacement value of the stroke of the hydraulic/pneumatic jack; and
a laser sensor having a body for sensing the lifting height and horizontal state of each unit weight and a clamp jig located on the outer surface of the body to fix the outer surface of the unit weight thereto.

6. The integrated lifting control system according to claim 1, wherein the main control panel is connected to the power units, the load cells of the hydraulic/pneumatic jacks, the spherical or semispherical bearings of the hydraulic/pneumatic jacks, the pressure sensors, the wire sensors, and the laser sensors and serves as a controller for controlling the loads of the unit weights during lifting, the pressure values of the unit weights, the strand wire movements and lengths, the lifting height, and the horizontal state, the main control panel comprising:
a body connected to the power units, the load cells of the hydraulic/pneumatic jacks, the spherical or semispherical bearings of the hydraulic/pneumatic jacks, the pressure sensors, the wire sensors, and the laser sensors by means of the cables; and
a monitor disposed on the upper portion of the body to monitor the corresponding values during the lifting of the unit weights.

7. An integrated lifting control system for controlling horizontal maintenance and loads of weights to thus vertically lift the weights used in various fields such as construction, shipbuilding, and the like and to integratedly control the loads of the weights, the integrated lifting control system provided by a lifting method comprising the steps of:
(S1) installing the power units for supplying hydraulic or pneumatic pressures to the hydraulic/pneumatic jacks;
(S2) installing the hydraulic/pneumatic jacks on tops of the power units by inserting the spherical or semispherical bearings into the CP blocks as support stands disposed on the outsides of the power units and mounting the load cells onto the strand wires;
(S3) connecting the power units and the hydraulic/pneumatic jacks to the main control panel by means of cables to check whether values sensed on lift points of the hydraulic/pneumatic jacks are normally obtained and the strand wires of the hydraulic/pneumatic jacks are maintained vertically;
(S4) sensing the loads of the unit weights by means of the load cells when the hydraulic or pneumatic pressures are introduced into the hydraulic/pneumatic jacks from the power units to vertically lift the unit weights and maintaining the strand wires vertically by means of the spherical or semispherical bearings to allow the unit weights to be vertically lifted at horizontal levels; and
(S5) performing synchronizing control for the hydraulic/pneumatic jacks in the range of ±5 to 20 mm per lift point according to lifting conditions (the load of each unit weight, the pressure value of the unit weight, the strand wire lengths, the lifting height, and the horizontal state of the unit weight) of the unit weights on the main control panel to thus lift up the unit weights vertically.

8. The integrated lifting control system according to claim 7, wherein before the step (S1), the lifting method comprises the steps of:
(S11) building the unit weights on the ground of a weight installation region or integratedly building the unit weights on a separate fabrication place to transfer the built unit weights to the ground of the weight installation region by means of a self propelled modular transporter (SPMT);
(S12) installing connecting pieces onto pad eyes pre-disposed on beams of the weight installation region and mounting the strand wires onto the connecting pieces; and
(S13) installing loading beams for supporting the integrated weights during lifting and jigs for performing the lifting on the undersides of the integrated unit weights and passing the strand wires through the hydraulic/pneumatic jacks, and
after the step (S5), the lifting method comprises the steps of:
(S51) fixedly installing the unit weights lifted up through the steps (S1) to (S4) on an installation position by means of bolting or welding performed by a worker on a lift; and
(S52) removing the loading beams and the jigs and separating the integrated lifting control system including the hydraulic/pneumatic jacks in the reverse order of the installation to organize the weight installation region.

9. The integrated lifting control system according to claim 2, wherein the hydraulic/pneumatic jacks are disposed on tops of the power units to operate with the hydraulic or pneumatic pressures supplied from the power units, each hydraulic/pneumatic jack comprising:
a body made of a metal material;
a press line disposed on top of the body to introduce the hydraulic or pneumatic pressure from the corresponding power unit and connected to the main control panel by means of a cable;
a cylinder disposed on the outside of the press line to move up and down the unit weights;
a pressure sensor mounting member and a wire sensor mounting member disposed on the outer surface of the body to mount a pressure sensor for sensing the pressure supplied to each hydraulic/pneumatic jack and a wire sensor for sensing the displacement length of the strand wire; and
bolt fastening holes formed on the underside of the body and fastened to bolt fastening holes of the power unit.
